(19) United States
(12) Patent Application Publication
(10) Pub. No.: US 2009/0172229 A1
(43) Pub. Date: Jul. 2, 2009

(54) METHODS FOR SELECTING CORES TO EXECUTE SYSTEM MANAGEMENT INTERRUPTS

(76) Inventor: Krystof Zmudzinski, Forest Grove, OR (US)

Correspondence Address: Barnes & Thornburg, LLP, c/o CPA Global, P.O. Box 52050, Minneapolis, MN, 55402, US

(21) Appl. No.: 11/966,341

(22) Filed: Dec. 28, 2007

(51) Int. Cl. G06F 13/24; G06F 9/46

(52) U.S. Cl. 710/260; 718/105

(57) ABSTRACT

A method includes directing a system management interrupt to a processor core from a plurality of processor cores of a computing device for handling based upon core load-sharing considerations. A machine readable medium includes a plurality of instruction, that in response to being executed, result in a computing device selecting a processor core of a plurality of processor cores to handle a system management interrupt and programming at least one system management register to direct the system management interrupt to the processor core selected from the plurality of processor cores for handling. An associated system is also disclosed.

### BACKGROUND

A system management interrupt (SMI) is a nonmaskable external interrupt that operates independently from a processor's interrupt- and exception-handling mechanism and a local interrupt controller, such as an Intel advanced programmable interrupt controller (APIC). SMIs take precedence over non-maskable and maskable interrupts. SMIs directed to a processing core indicate that a processing core is to transition to system management mode (SMM), which is a special-purpose operating mode provided for handling system-wide functions, such as power management, system hardware control, or proprietary OEM (Original Equipment Manufacturers)-designed code, for example.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows a block diagram of a system including a plurality of processors.

FIG. 2 shows a flowchart of an illustrative method of processing a system management interrupt in a system.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as types and interrelationships of system components and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

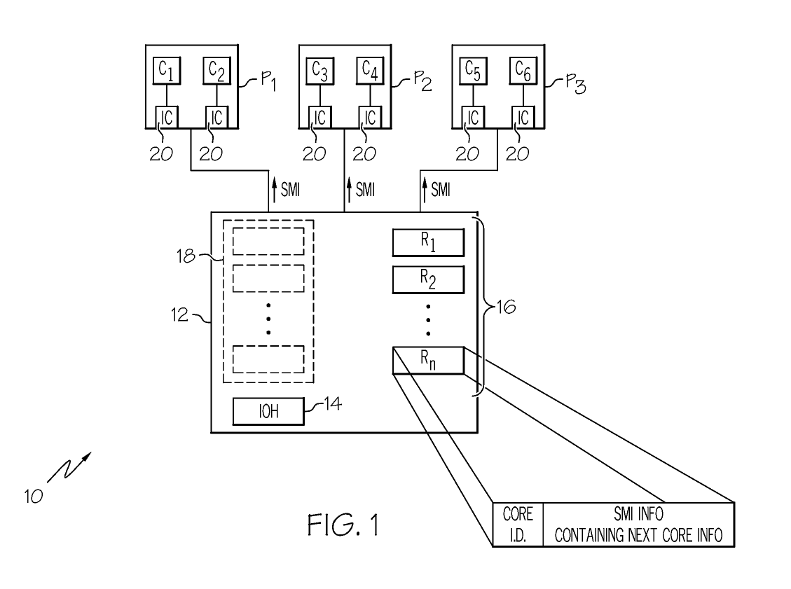

Referring now to FIG. 1, there is shown an embodiment of a system 10 having a plurality of processors P₁-P₃ each connected to a chipset 12. A multiprocessor configuration such as that shown in FIG. 1 may be used in variety of applications, such as in a server, for example. The chipset 12 may include various controllers such as an input/output hub 14. During operation of the system 10, system management interrupts (SMIs) may be delivered to the various processors P1-P₃. SMIs may be generated within the system 10 by various controllers, such as the input/output hub 14, for example, or other components. An SMI may instruct processing cores in a system, such as system 10, to enter system management mode (SMM).

As shown in FIG. 1, the processors P₁-P₃ may each include a plurality of processing cores associated therewith that may operate independently from one another. Each processor P₁-P₃ is illustratively shown as including two cores designated as “cₙ.” However, it should be appreciated that each processor may include a number of cores other than that illustratively shown in FIG. 1. It should be further appreciated that each core may be a hardware thread, a logical core, or a physical core. When the system 10 enters SMM, cores c₁-c₆ may be synchronized if they are all to be transitioned to SMM. However, this can typically take more time than desired as each core is transitioned into SMM. Furthermore, conditions may exist when less than all of the cores need to be transitioned to SMM. Conditions may also exist in which a single core may be transitioned to SMM to carry out instructions contained in the SMI. Cores not required to be transitioned to SMM may instead be halted in their operation, thus conserving time that would be spent saving a current state of a core before transitioning to SMM. Each processor P1-P3 may include an interrupt controller 20 associated with each core, such as an Intel advanced programmable interrupt controller, which may inspect an SMI to determine if it is intended for a specific core and direct it to an associated core, i.e. a core connected to the same processor as the interrupt controller 20, selected to execute the SMI.

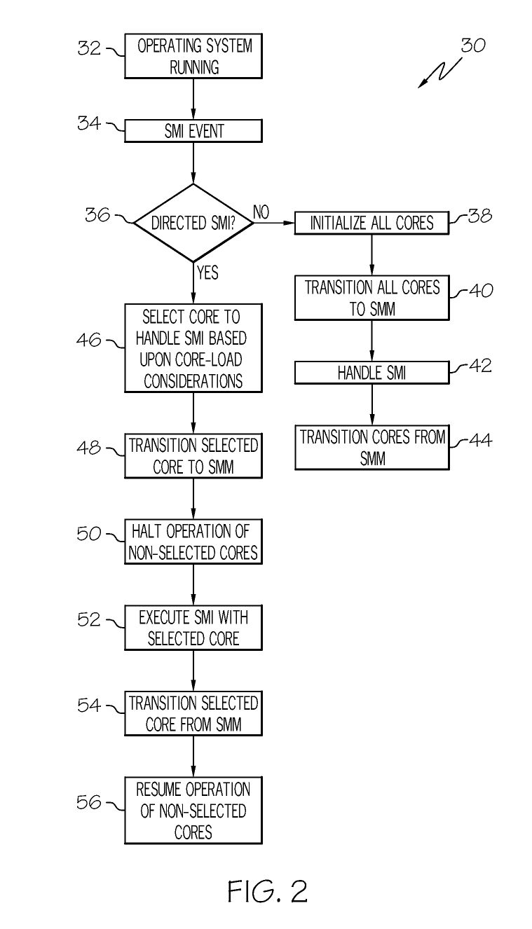

Referring now to FIG. 2, a flowchart 30 illustrates a method of processing an interrupt in a system 10. At block 32, the operating system is running on a system such as system 10. At block 34, an SMI event occurs which may generate an SMI. At block 36, a determination is made as to if a generated SMI is to be directed to a single core for execution or to all cores, such as all cores c₁-c₆ of the system 10. If the SMI is not intended for a single core, all cores may be initialized at block 38 for SMM. At block 40, all cores in the system may be transitioned to SMM. At block 42, the generated SMI may be handled. At block 44, all cores may be transitioned back from SMM and the cores may continue to run on the operating system or may execute another SMI.

If, at block 36, the SMI is determined to be directed to a single core, a core to execute the SMI is selected based upon core load-sharing considerations. For example, in the system 10, basing the SMI directing on these considerations allows the SMI processing load to be distributed among all of the cores c₁-c₆ based upon various factors such as the current load of each core at the time an SMI is to be generated or core load over an observed window of time, as well as physical characteristics, such as the temperature of the cores c₁-c₆. Various algorithms may be implemented to take these factors into consideration in order to select a core to which an SMI is directed. Furthermore, a counter may be maintained in the chipset 12. For example, a counter may be stored by a register 18 of the chipset 12 and updated in response to a system management interrupt. The count values of the counter may correspond to core identifiers of the cores c₁-c₆ and thus identify which core is to receive an SMI for handling. Use of a counter distributes the SMI load amongst the cores in the system without regard for particular core conditions. However, various conditions, as previously discussed, may be considered.

Referring back to FIG. 2, at block 48 the core selected at block 46 is transitioned to SMM. At block 50, the non-selected cores may be halted in operation. At block 52, the SMI may be executed by the selected core. At block 54, the selected core may be transitioned back from SMM. At block 56, the halted non-selected cores may resume operation.

Referring again to FIG. 1, in one embodiment, an SMI may be handled by one particular core in the system 10. As shown in FIG. 1, the chipset 12 may include an SMM-related register set 16 that may be used for SMM applications. Each register R₁-Rₙ may contain SMI information, as well as information relating to a particular core to which an SMI may be directed. As illustrated, the registers R₁-Rₙ may contain information regarding an SMI that may be directed to a single core in the system 10.

In one embodiment, the registers R₁-Rₙ in the register set 16 may be programmed by the BIOS (basic input/output system). The register Rₙ may contain a core identifier for a core c₁-c₆ that is to receive an SMI, designated as “Core I.D.” in FIG. 1. The SMI handler vector software may contain information relating to which core may be used to handle an SMI for the next SMI generated for a single core in the system (designated as “SMI Vector to SMI Handler Containing Next Core Info” in FIG. 1). It should be appreciated that the Core I.D. may also be part of the SMI information.

In one embodiment, an SMI may be directed toward the core c₁. The SMI may be handled by core c₁, with part of the SMI execution relating to programming the registers R₁-Rₙ with information relating to which core is to receive the next SMI generated for a single core. As each SMI is generated for a single core, the SMI handling software may reprogram a particular register R₁-Rₙ being used such that a different core may be scheduled for the next SMI. The software may implement various algorithms to determine which core receives the next SMI, such as those previously discussed.

In one embodiment, SMI registers R₁-Rₙ, may be programmed to automatically select a core c₁-c₆ in the system 10 to execute an SMI. For example, the system 10 may be initially booted up such that the BIOS of the system 10 programs the registers R₁-Rₙ to automatically select cores in the system 10 to receive SMIs intended to be executed by a single core. The registers R₁-Rₙ, may select each core to receive an SMI using any of the various core-load consideration (e.g., the amount of use a core is enduring) algorithms discussed herein. In one embodiment a platform of the system 10 may include an additional register set 18 having core selection algorithms based upon core-load considerations stored therein. The registers R₁-Rₙ, may be programmed to be directed to the additional registers to receive identification of a core selected by an algorithm.

In one embodiment, the registers R₁-Rₙ, may be programmed with the identification of cores in the system 10 eligible to receive SMIs to be executed by a single core. This programming may be performed by one or more BIOS routines when the system 10 is booted up. In one embodiment, additional registers, such as the register set 18 may be programmed with various core-selection algorithms may be exposed such that the registers R₁-Rₙ may be used in conjunction with the registers of register set 20 to select eligible cores for receiving SMIs using the core-selection algorithms discussed herein. When the SMIs are handled, the SMI handler code may reprogram the registers R₁-Rₙ, based on additional information, such as an operating system of the system 10 informing BIOS which core is used for operating system BSP (boot strap processor), real-time jobs, etc., such that those cores may be excluded from eligibility for executing SMIs.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

What is claimed is:

1. A method comprising directing a system management interrupt to a processor core from a plurality of processor cores of a computing device for handling based upon core load-sharing considerations.

2. The method of claim 1, further comprising programming, based upon the core load-sharing considerations, at least one system management interrupt register to direct the system management interrupt to the processor core.

3. The method of claim 1, further comprising programming, based upon the core load-sharing consideration, at least one system management interrupt register to direct the system management interrupt to the processor core in response to a previous execution of a system management interrupt handler associated with the system management interrupt.

4. The method of claim 1, further comprising programming, based upon current load of each core of the plurality of cores, at least one system management interrupt register to direct the system management interrupt to the processor core in response to a previous execution of a system management interrupt handler associated with the system management interrupt.

5. The method of claim 1, further comprising programming, based upon current load of each core of the plurality of cores, at least one system management interrupt register to direct the system management interrupt to the processor core in response to determining that the processor core has the lowest current load.

6. The method of claim 1, further comprising updating a count value of a counter in response to each generated system management interrupt to direct the system management interrupt to a processing core of the plurality of processing cores that has a core identifier corresponding to the count value of the counter.

7. The method of claim 1, further comprising programming at least one system management interrupt register to direct the system management interrupt to the processor core based upon temperature of the cores.

8. The method of claim 1, further comprising
determining current load of each processor core of the plurality of processor cores, and
programming at least one system management interrupt register based upon the current load of each processor core of the plurality of processor cores to direct the system management interrupt to the processor core.

9. The method of claim 1,
determining that the processor core has the lowest current load of the plurality of processor cores, and
programming at least one system management interrupt register to direct the system management interrupt to the processor core in response to determining that the processor core has the lowest current load.

10. A machine readable medium comprising a plurality of instruction, that in response to being executed, result in a computing device
selecting a processor core of a plurality of processor cores to handle a system management interrupt, and
programming at least one system management register to direct the system management interrupt to the processor core selected from the plurality of processor cores for handling.

11. The machine readable medium of claim 10 wherein the plurality of instructions in response to being executed, further result in the computing device
determining a processing load for each processor core of the plurality of processor cores, and
selecting the processor core having the lowest processing load to handle the system management interrupt.

12. The machine readable medium of claim 10 wherein the plurality of instructions in response to being executed, further result in the computing device
determining a temperature for each processor core of the plurality of processor cores, and
selecting the processor core based upon the temperature for each processor core of the plurality of processor cores.

13. The machine readable medium of claim 10 wherein the plurality of instructions in response to being executed, further result in the computing device
programming the at least one system management interrupt register in response a previous execution of a system management interrupt handler associated with the system management interrupt.

14. The machine readable medium of claim 10 wherein the plurality of instructions in response to being executed, further result in the computing device
programming the at least one system management interrupt register to associate a system management interrupt handler with the system management interrupt, and
selecting the processor core in response to a previous execution of the system management interrupt handler.

15. A system comprising:
a computing device having a plurality of processors, each processor comprising a plurality of processing cores,
wherein, the computing device is configured to select one of the processing cores to handle a system management interrupt based upon core load-sharing considerations.

16. The system of claim 15, wherein each processor comprises a plurality of interrupt controller, each interrupt controller associated with one of the plurality of processing cores of the respective processor,
wherein, each interrupt controller determines if the associated processing core is to handle the system management interrupt.

17. The system of claim 15, wherein the computing device further comprises at least one system management interrupt register to direct the system management interrupt to the selected processor core.

18. The system of claim 16, wherein, the computing device is further configured to select the processing core having the lowest processing load.
